(19) United States
(12) Patent Application Publication
(10) Pub. No.: US 2014/0092020 A1
(43) Pub. Date: Apr. 3, 2014

(54) AUTOMATIC ASSIGNMENT OF KEYBOARD LANGUAGES

(71) Applicants: Yaad Hadar, Adi (IL); Igor Ljubuncic, Yokneam Ilit (IL); Avikam Rozenfeld, Haifa (IL); Raphael Sack, Mitzpe Amuka (IL)

(72) Inventors: Yaad Hadar, Adi (IL); Igor Ljubuncic, Yokneam Ilit (IL); Avikam Rozenfeld, Haifa (IL); Raphael Sack, Mitzpe Amuka (IL)

(21) Appl. No.: 13/629,957

(22) Filed: Sep. 28, 2012

(51) Int. Cl. G06F 3/02

(52) U.S. Cl. 345/168

(57) ABSTRACT

Systems and methods may provide for receiving web content and identifying a language of the web content. Additionally, the language may be automatically assigned to a keyboard. In one example, the language of the web content is identified by identifying a meta tag such as a content language meta tag or a content type meta tag in one or more HTML (hypertext markup language) pages of the web content.

### BACKGROUND

Embodiments generally relate to keyboard technology. More particularly, embodiments relate to the automatic assignment of keyboard languages.

Many Internet users across the world may navigate to different websites that display content in different languages. For example, a typical user in Israel may have several browser sessions opened simultaneously, with some being written in the English language and some being written in a non-English language (e.g., Hebrew, Chinese, etc.). In order to be able type in the correct language, however, the user may be required to manually switch the keyboard language back and forth between English and non-English keyboard layouts when changing tabs or navigating to new websites. Such a scenario may lead to countless cases of the user starting to type in the wrong language, deleting the typed information, changing the keyboard language and typing again in the appropriate language.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is an illustration of a keyboard management scheme according to an embodiment;

FIG. 2 is a block diagram of a browser module according to an embodiment;

FIG. 3 is a flowchart of an example of a method of managing keyboard languages according to an embodiment;

FIG. 4 is a block diagram of an example of a processor according to an embodiment; and

FIG. 5 is a block diagram of an example of a system according to an embodiment.

### DETAILED DESCRIPTION

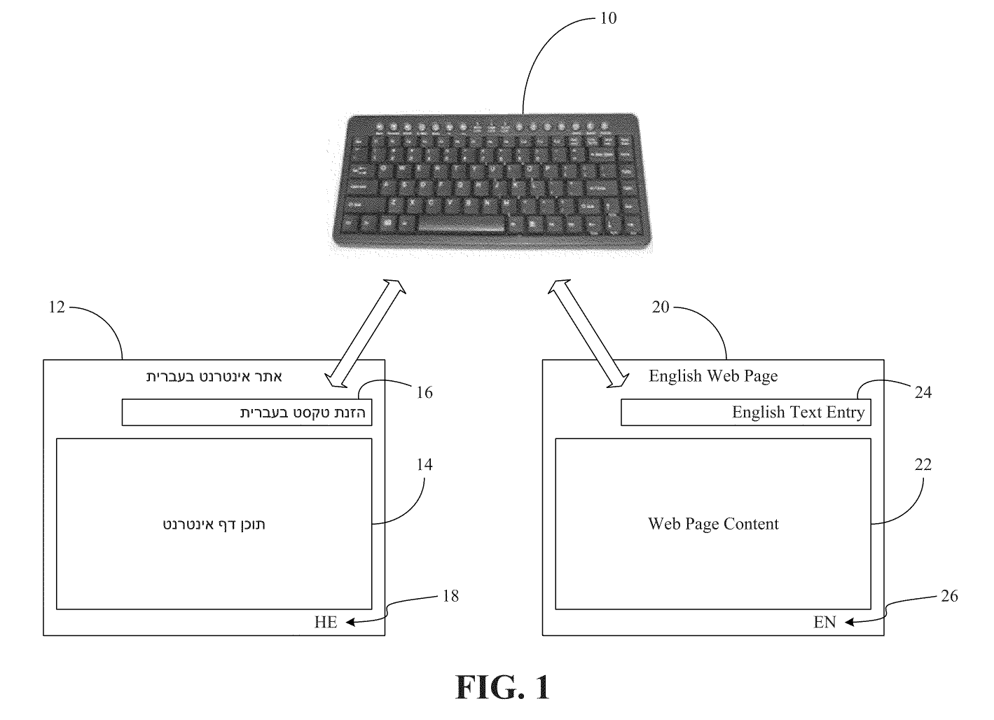

Turning now to FIG. 1, a keyboard management scheme is shown in which a keyboard 10 is able to automatically switch between languages based on web content encountered in a browser. More particularly, a first web page 12 having content 14 that is written in a first language (e.g., Hebrew), contains a text entry field 16 that receives a typed text entry that is also in the first language. More particularly, the keyboard 10 is automatically configured to have a layout and character output configuration that corresponds to the first language, as demonstrated by the “HE” keyboard status indicator 18. A second web page 20, on the other hand, has content 22 that is written in a second language (e.g., English), and contains a text entry field 24 that receives a typed text entry that is in the second language. In the illustrated example, the second language is automatically assigned to the keyboard 10 upon receipt of the web page 20, as demonstrated by the “EN” keyboard status indicator 26. Accordingly, the user of the keyboard 10 is no longer burdened with manually switching between keyboard languages, or deleting and re-typing text in the correct language once the keyboard language has been corrected. Although the keyboard 10 is illustrated as a hardware keyboard, software based keyboards (e.g., on screen keyboards, softkeyboards) may also implement the illustrated keyboard management scheme. Additionally, the keyboard 10 may be coupled to and/or part of any type of computing platform such as a desktop computer, workstation, notebook computer, smart tablet, smart phone, personal digital assistant (PDA), and so forth.

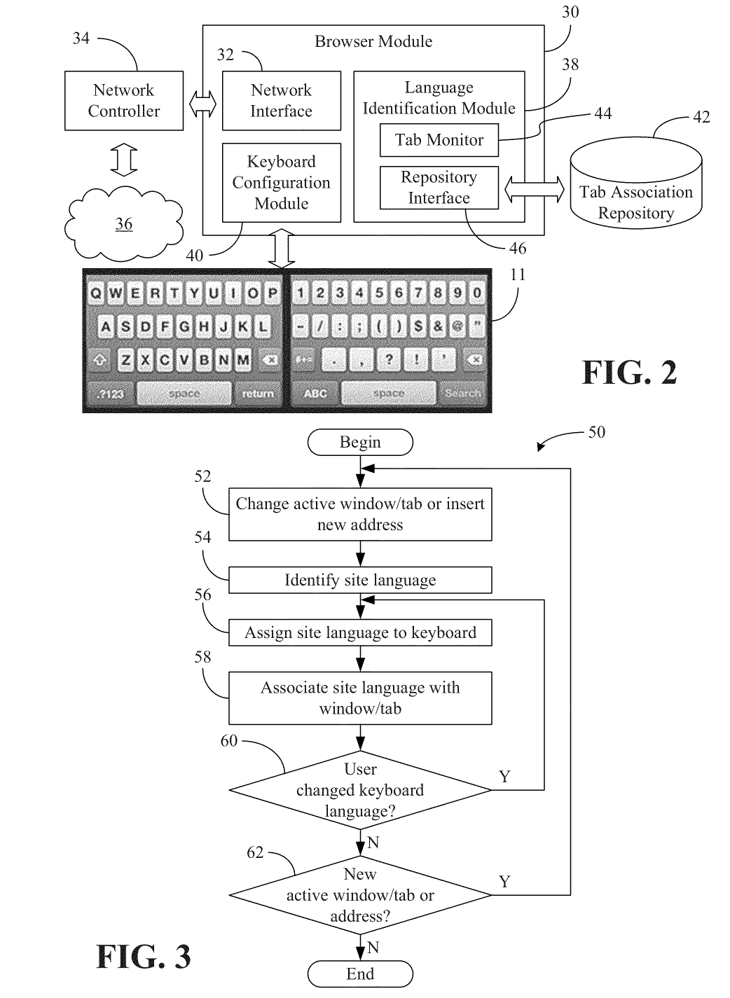

FIG. 2 shows a logic architecture having a browser module 30 that is configured to automatically assign keyboard languages. In the illustrated example, a network interface 32 receives web content via a network controller 34 and a network 36 such as the Internet. The web content, which may include one or more hypertext markup language (HTML) pages having page headers with meta tags that are indicative of the language of the web content (e.g., site language), may be analyzed by a language identification module 38 to determine the language of the web content. Thus, the web content might include a page such as the first web page 12 (FIG. 1) written in a non-English language. Alternatively, the web content may include a page such as the second web page 20 (FIG. 1) written in English. The meta tags that are inspected by the illustrated language identification module 38 may include, for example, a content language meta tag (e.g., META HTTP-EQUIV=“content-language” CONTENT=“en-US”), a content type meta tag (e.g., META HTTP-EQUIV=“Content-Type” CONTENT=“text/html; charset=ISO-8859-8”), and so forth. The browser module 30 may also include a keyboard configuration module 40 that assigns the language of the web content to a software based keyboard 11.

The language identification module 38 may also associate the language with a browser tab and/or window corresponding to the web content in a tab association repository 42 (e.g., last tab language). In this regard, the illustrated browser module 30 also includes a tab monitor 44 that detects selections by the user of browser tabs and/or windows, wherein a repository interface 46 may use the tab association repository 42 to identify a language associated with each selected tab and/or window. Accordingly, the keyboard configuration module 40 may also assign languages identified in the tab association repository 42 to the keyboard 11.

Turning now to FIG. 3, a method 50 of managing keyboard languages is shown. The method 50 may be implemented as a set of logic instructions and/or firmware stored in a machine- or computer-readable medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 50 may be written in any combination of one or more programming languages, including an object oriented programming language such as C++ or the like and conventional procedural programming languages, such as the “C” programming language or similar programming languages. Moreover, the method 50 may be implemented as the browser module 30 (FIG. 1) using any of the aforementioned circuit technologies.

Illustrated processing block 52 provides for changing an active window/tab or inserting a new web page address (e.g., URL/uniform resource locator) in an address bar of a browser. The site language may be identified at block 54 by, for example, either analyzing a meta tag of the corresponding web content (e.g., for new addresses) or retrieving a tab-language association from a repository such as the tab association repository 42 (FIG. 2), as already discussed. Block 56 may assign the site language to a keyboard such as a peripheral keyboard (e.g., USB/Universal Serial Bus keyboard), an embedded keyboard/keypad, a softkeyboard, and so forth. The assignment of the site language to the keyboard may be implemented by, for example, writing to a configuration register and/or memory location associated with the keyboard, transmitting a signal to the keyboard, etc.

The site language may also be associated with a tab/window corresponding to the web content at block 58, wherein illustrated block 60 determines whether the user has manually changed the keyboard language. If so, the new keyboard language may be assigned to the keyboard and the appropriate tab/window. Otherwise, a determination may be made at block 62 as to whether a new window/tab or address has been requested. If so, the method 50 may be repeated for the web content associated with the request.

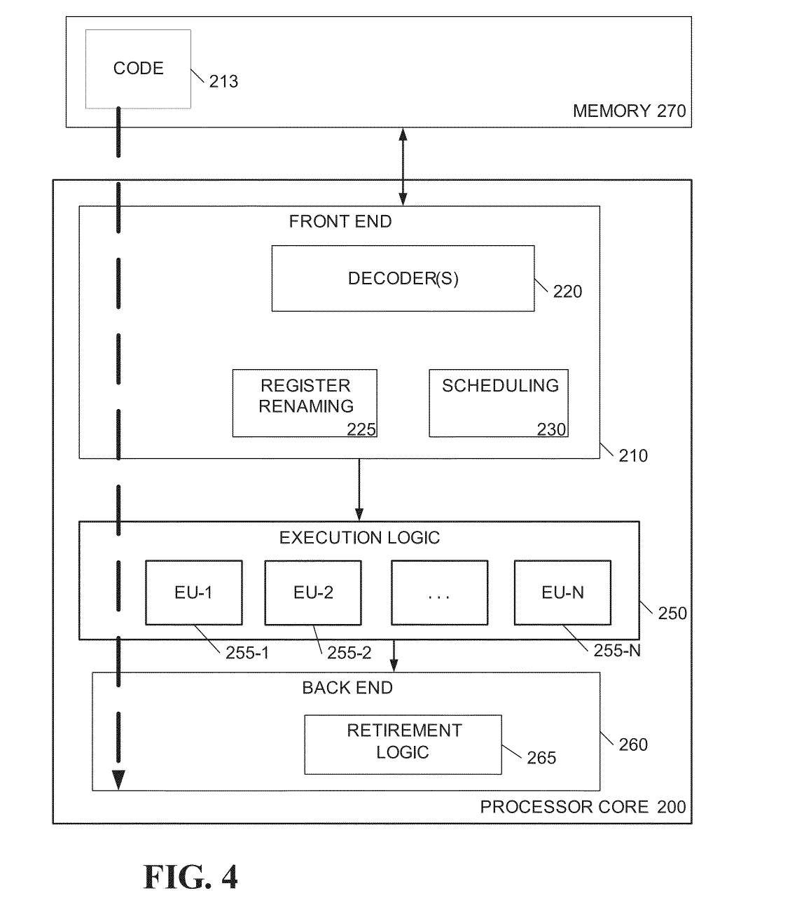

FIG. 4 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 4, a processing element may alternatively include more than one of the processor core 200 illustrated in FIG. 4. The processor core 200 may be a single-threaded core or, for at least one embodiment, the processor core 200 may be multithreaded in that it may include more than one hardware thread context (or “logical processor”) per core.

FIG. 4 also illustrates a memory 270 coupled to the processor 200. The memory 270 may be any of a wide variety of memories (including various layers of memory hierarchy) as are known or otherwise available to those of skill in the art. The memory 270 may include one or more code 213 instruction(s) to be executed by the processor 200 core, wherein the code 213 may implement the browser module 30 (FIG. 2), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 4, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

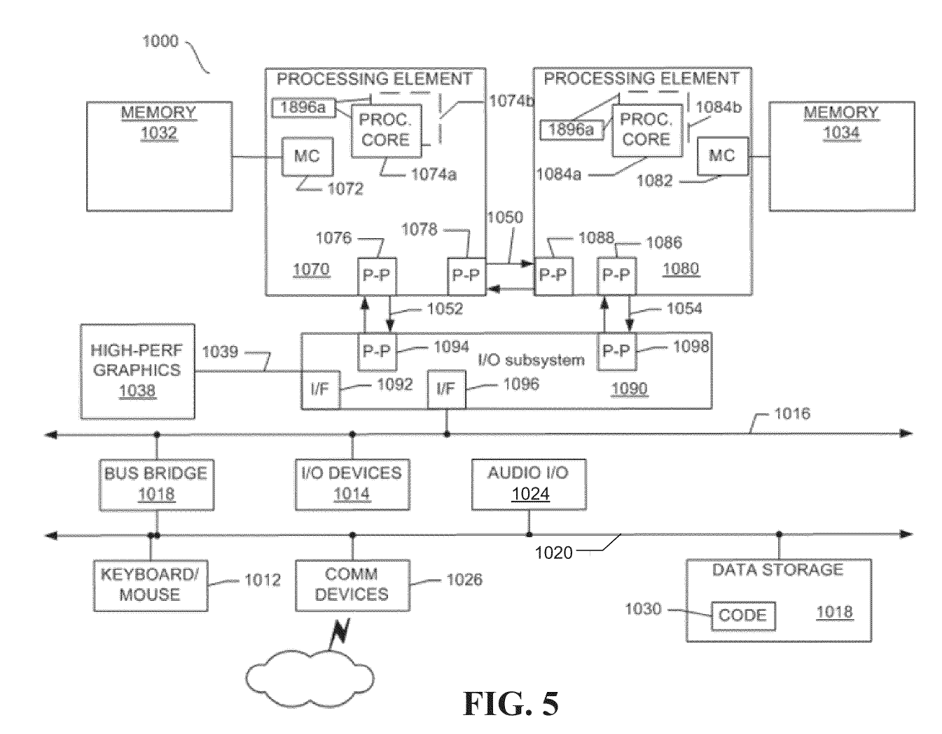

Referring now to FIG. 5, shown is a block diagram of a system 1000 in accordance with an embodiment of the present invention. Shown in FIG. 5 is a multiprocessor system 1000 that includes a first processing element 1070 and a second processing element 1080. While two processing elements 1070 and 1080 are shown, it is to be understood that an embodiment of system 1000 may also include only one such processing element.

System 1000 is illustrated as a point-to-point interconnect system, wherein the first processing element 1070 and second processing element 1080 are coupled via a point-to-point interconnect 1050. It should be understood that any or all of the interconnects illustrated in FIG. 5 may be implemented as a multi-drop bus rather than point-to-point interconnect.

As shown in FIG. 5, each of processing elements 1070 and 1080 may be multicore processors, including first and second processor cores (i.e., processor cores 1074a and 1074b and processor cores 1084a and 1084b). Such cores 1074, 1074b, 1084a, 1084b may be configured to execute instruction code in a manner similar to that discussed above in connection with FIG. 4.

Each processing element 1070, 1080 may include at least one shared cache 1896. The shared cache 1896a, 1896b may store data (e.g., instructions) that are utilized by one or more components of the processor, such as the cores 1074a, 1074b and 1084a, 1084b, respectively. For example, the shared cache may locally cache data stored in a memory 1032, 1034 for faster access by components of the processor. In one or more embodiments, the shared cache may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the present invention is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

First processing element 1070 may further include memory controller logic (MC) 1072 and point-to-point (P-P) interfaces 1076 and 1078. Similarly, second processing element 1080 may include a MC 1082 and P-P interfaces 1086 and 1088. As shown in FIG. 5, MC's 1072 and 1082 couple the processors to respective memories, namely a memory 1032 and a memory 1034, which may be portions of main memory locally attached to the respective processors. While the MC logic 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076, 1086 and 1084, respectively. As shown in FIG. 5, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple graphics engine 1038 to I/O subsystem 1090. Alternately, a point-to-point interconnect 1039 may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the present invention is not so limited.

As shown in FIG. 5, various I/O devices 1014 may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1018 such as a disk drive or other mass storage device which may include code 1030, in one embodiment. In one example, web content is received via the communication devices 1026. The code 1030 may include instructions for performing embodiments of one or more of the methods described above. Thus, the illustrated code 1030 may implement the browser module 30 (FIG. 2) and may be similar to the code 213 (FIG. 4), already discussed. Further, an audio I/O 1024 may be coupled to second bus 1020.

Note that other embodiments are contemplated. For example, instead of the point-to-point architecture of FIG. 5, a system may implement a multi-drop bus or another such communication topology. Also, the elements of FIG. 5 may alternatively be partitioned using more or fewer integrated chips than shown in FIG. 5.

Examples may include a keyboard management system having a keyboard, a network controller, and a browser module. The browser module may include a network interface to receive web content via the network controller, a language identification module to identify a language of the web content, and a keyboard configuration module to assign the language to the keyboard.

Additionally, the language identification module of the system may identify a meta tag in the web content to identify the language.

Additionally, the meta tag of the system may be a content language meta tag.

Moreover, the meta tag of the system may be a content type meta tag.

In addition, the system may further include a tab association repository, wherein the language identification module is to associate the language with a first browser tab corresponding to the web content in the tab association repository.

In addition, the language identification module of the system may include a tab monitor to detect a selection of a second browser tab, and a repository interface to use the tab association repository to identify a language associated with the second browser tab, wherein the keyboard configuration module is to assign the language associated with the second browser tab to the keyboard.

Moreover, the network interface of any of the aforementioned system examples may receive one or more hypertext markup language (HTML) web pages as the web content.

Examples may also include a keyboard management apparatus having network interface to receive web content and a language identification module to identify a language of the web content. The apparatus may also include a keyboard configuration module to assign the language to the keyboard.

Additionally, the language identification module of the apparatus may identify a meta tag in the web content to identify the language.

Additionally, the meta tag of the apparatus may be a content language meta tag.

Moreover, the meta tag of the apparatus may be a content type meta tag.

In addition, the apparatus may further include a tab association repository, wherein the language identification module is to associate the language with a first browser tab corresponding to the web content in the tab association repository.

In addition, the language identification module of the apparatus may include a tab monitor to detect a selection of a second browser tab, and a repository interface to use the tab association repository to identify a language associated with the second browser tab, wherein the keyboard configuration module is to assign the language associated with the second browser tab to the keyboard.

Moreover, the network interface of any of the aforementioned apparatus examples may receive one or more hypertext markup language (HTML) web pages as the web content.

Examples may also include a method of managing a keyboard in which web content is received and a language of the web content is identified. The method may also provide for assigning the language to the keyboard.

Additionally, identifying the language of the web content may include identifying a meta tag in the web content.

Additionally, the meta tag of the method may be a content language meta tag.

Moreover, the meta tag of the method may be a content type meta tag.

In addition, the method may further include associating the language with a first browser tab corresponding to the web content.

In addition, the method may further include detecting a selection of a second browser tab, identifying a language associated with the second browser tab, and assigning the language associated with the second browser tab to the keyboard.

Moreover, receiving the web content in any of the aforementioned method examples may include receiving one or more hypertext markup language (HTML) web pages.

Examples may also include a keyboard management apparatus having means to perform any of the aforementioned method examples.

Examples may also include at least one computer readable storage medium having a set of instructions which, when executed by a processor, cause a computer to receive web content. The instructions may also cause a computer to identify a language of the web content and assign the language to a keyboard.

Additionally, the instructions, when executed, may cause a computer to identify a meta tag in the web content to identify the language.

Additionally, the meta tag of the at least one medium may be a content language meta tag.

Moreover, the meta tag of the at least one medium may be a content type meta tag.

In addition, the instructions, when executed, may cause a computer to associate the language with a first browser tab corresponding to the web content.

In addition, the instructions, when executed, may cause a computer to detect a selection of a second browser tab, identify a language associated with the second browser tab, and assign the language associated with the second browser tab to the keyboard.

Moreover, the instructions of any of the aforementioned medium examples, when executed, may cause a computer to receive one or more hypertext markup language (HTML) web pages as the web content.

Technologies described herein may therefore provide a seamless browsing experience in which any need to manually switch between languages or retype information is obviated. Additionally, such a solution may be relevant to the majority of Internet users—namely, non-English native speakers who surf sites in multiple languages. Moreover, the techniques described herein may be well suited for standardization across a wide variety of browsers and platforms (e.g., desktops, mobile platforms, smartphones, etc.).

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size may be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a keyboard;
a network controller; and
a browser module including,
a network interface to receive web content via the network controller,
a language identification module to identify a language of the web content, and
a keyboard configuration module to assign the language to the keyboard.

2. The system of claim 1, wherein the language identification module is to identify a meta tag in the web content to identify the language.

3. The system of claim 2, wherein the meta tag is to be a content language meta tag.

4. The system of claim 2, wherein the meta tag is to be a content type meta tag.

5. The system of claim 1, further including a tab association repository, wherein the language identification module is to associate the language with a first browser tab corresponding to the web content in the tab association repository.

6. The system of claim 5, wherein the language identification module includes:
a tab monitor to detect a selection of a second browser tab, and
a repository interface to use the tab association repository to identify a language associated with the second browser tab, wherein the keyboard configuration module is to assign the language associated with the second browser tab to the keyboard.

7. The system of claim 1, wherein the network interface is to receive one or more hypertext markup language (HTML) web pages as the web content.

8. An apparatus comprising:
a network interface to receive web content;
a language identification module to identify a language of the web content; and
a keyboard configuration module to assign the language to a keyboard.

9. The apparatus of claim 8, wherein the language identification module is to identify a meta tag in the web content to identify the language.

10. The apparatus of claim 9, wherein the meta tag is to be a content language meta tag.

11. The apparatus of claim 9, wherein the meta tag is to be a content type meta tag.

12. The apparatus of claim 8, further including a tab association repository, wherein the language identification module is to associate the language with a first browser tab corresponding to the web content in the tab association repository.

13. The apparatus of claim 12, wherein the language identification module includes:
a tab monitor to detect a selection of a second browser tab; and
a repository interface to use the tab association repository to identify a language associated with the second browser tab, wherein the keyboard configuration module is to assign the language associated with the second browser tab to the keyboard.

14. The apparatus of claim 8, wherein the network interface is to receive one or more hypertext markup language (HTML) web pages as the web content.

15. A method comprising:
receiving web content;
identifying a language of the web content; and
assigning the language to a keyboard.

16. The method of claim 15, wherein identifying the language of the web content includes identifying a meta tag in the web content.

17. The method of claim 16, wherein the meta tag is a content language meta tag.

18. The method of claim 16, wherein the meta tag is a content type meta tag.

19. The method of claim 15, further including associating the language with a first browser tab corresponding to the web content.

20. The method of claim 19, further including:
detecting a selection of a second browser tab;
identifying a language associated with the second browser tab; and
assigning the language associated with the second browser tab to the keyboard.

21. The method of claim 15, wherein receiving the web content includes receiving one or more hypertext markup language (HTML) web pages.

22. At least one computer readable storage medium comprising a set of instructions which, when executed by a processor, cause a computer to:
receive web content;
identify a language of the web content; and
assign the language to a keyboard.

23. The at least one computer readable storage medium of claim 22, wherein the instructions, when executed, cause a computer to identify a meta tag in the web content to identify the language.

24. The at least one computer readable storage medium of claim 23, wherein the meta tag is to be a content language meta tag.

25. The at least one computer readable storage medium of claim 23, wherein the meta tag is to be a content type meta tag.

26. The at least one computer readable storage medium of claim 22, wherein the instructions, when executed, cause a computer to associate the language with a first browser tab corresponding to the web content.

27. The at least one computer readable storage medium of claim 26, wherein the instructions, when executed, cause a computer to:
detect a selection of a second browser tab;
identify a language associated with the second browser tab; and
assign the language associated with the second browser tab to the keyboard.

28. The at least one computer readable storage medium of claim 22, wherein the instructions, when executed, cause a computer to receive one or more hypertext markup language (HTML) web pages as the web content.
